(19) United States
(12) Patent Application Publication
(10) Pub. No.: US 2025/0377638 A1
(43) Pub. Date: Dec. 11, 2025

(54) METHOD FOR PROVIDING AID TO THE INDUSTRIAL WORKFORCE BASED ON INTELLIGENT LEARNING AND A SYSTEM THEREOF

(71) Applicant: Honeywell International Inc., Charlotte, NC (US)

(72) Inventors: Jaikrishna R, Bangalore (IN); Subhan Dudekula, Bangalore (IN); Mukul Kumar, Jhansi (IN); Subiya S, Nagapattinam (IN); Mandela Mahato, Bengaluru (IN); Unnikrishnan Poduval, Bangalore (IN)

(21) Appl. No.: 18/733,864

(22) Filed: Jun. 5, 2024

(51) Int. Cl. G05B 13/02

(52) U.S. Cl. CPC G05B 13/027

(57) ABSTRACT

The present invention relates to a method for providing aid to the industrial workforce based on intelligent learning, comprising receiving a query via an input acceptor, routing the query to an autodidact engine, said autodidact engine comprising a knowledge base and a native accumulator. The method further comprises receiving, by a data segregator, data associated with a product or services from one or more data sources, said data sources including at least a product data source, a customer data source and a tribal knowledge source and segregating, by the data segregator, the received data from said data sources into structured and unstructured data. Further, the method comprises providing, by the data segregator, the structured and the unstructured data to the native accumulator and performing, by the native accumulator, one or more operations to process the received data from the segregator. Further, the method includes storing the processed data from the native accumulator into the knowledge base. Further, the deep learning framework is executed to process the data from the native accumulator and provides the responses to the customer corresponding to the query received through the user input acceptor.

### TECHNICAL FIELD

Present disclosure relates to a system and a method of managing operations in an industrial workspace, and particularly, relates to providing aid to the industrial workforce based on knowledge base and intelligent learning.

### BACKGROUND

In an industrial process, typically, there are numerous processes and each process may involve one or more assets which performs the process. Each asset in the process has a particular function variable/standard operating procedure and in many situations, there could be anomaly in function variables. The workforce, which involves skilled technician, asset operators, performance monitoring technicians, regularly monitors the functioning of the different assets and its functional variable and are responsible for smooth functioning of processes in the industry. However, there can be instances, where one or more assets does not function as expected resulting in downtime and in such scenario, the skilled technician may refer to log book or manuals to assess the corrective action to be taken in respect of such non-performing asset.

There are numerous challenges like handling of equipment failure, production issues, functional issues, knowing how, technical support, time management etc. In a plant facility, there are workforce including experts, equipment operators, maintenance engineers who are involved in running and executing the asset or equipment on day-to-day basis. However, any failure in the asset/equipment, underlying products needs to be resolved in quick turn-around time to have minimum impact on overall functioning of the facility.

Whenever there is an issue with equipment/devices/products/assets, the workforce at the facilities have to rely on their competency, approach the in-house expertise/support team to get resolutions/propositions with interim approaches. However, such measures may take longer time resolution of the issues and often affects the overall functioning of the equipment/plant. In many instances, the skilled technician may refer to log book or manuals to assess the corrective action to be taken in respect of such non-performing asset and this may take longer time for providing resolution to an issue, because of the reasons that the manuals may not have a resolution to the current problem at hand or the manual can be an exhaustive document which may need lot of time in reviewing and assessing the best solution for the identified problem.

Also, there can be situations, where the process variables and standard operating procedures of an equipment may vary from industry to industry. Therefore, a resolution which works in a first industry with respect to the equipment may not be appropriate in the second industry and a skilled person in a new industrial environment may not be able to find quick resolution to the identified problem with the equipment, as the equipment in the first industry and the second industry may be functioning in different operating conditions.

There exists a need for providing a solution to the above drawbacks by providing the workforce/frontline workers with mechanisms which can provide/suggest quick resolutions through interactive devices/interfaces.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure herein provide a system and a method for providing aid to the workforce in an industrial process. Other implementations will be, or will become, apparent to one with skill in the art upon examination of the following figures and detailed description. It is intended that all such additional implementations be included within this description be within the scope of the disclosure.

The present invention relates to a method for providing aid to the industrial workforce based on intelligent learning, comprising receiving a query via an input acceptor, routing the query to an autodidact engine, said autodidact engine comprising a knowledge base and a native accumulator. The method further comprises receiving, by a data segregator, data associated with a product or services from one or more data sources, said data sources including at least a product data source, a customer data source and a tribal knowledge source and segregating, by the data segregator, the received data from said data sources into structured and unstructured data. Further, the method comprises providing, by the data segregator, the structured and the unstructured data to the native accumulator and performing, by the native accumulator, one or more operations to process the received data from the segregator. Further, the method includes storing the processed data from the native accumulator into the knowledge base. Further, the deep learning framework is executed to process the data from the native accumulator and provides the responses to the customer corresponding to the query received through the user input acceptor.

In another aspect, the present invention provides a system for providing aid to the industrial workforce based on intelligent learning, comprising an input acceptor for receiving a query from a customer. An autodidact engine is coupled to the input acceptor for receiving the query, said autodidact engine comprising a knowledge base, a native accumulator and a deep learning framework. A data segregator is coupled to the native accumulator, wherein the data segregator is configured to receive data from one or more sources, said sources including product data, customer data and tribal knowledge data and segregate the received data into structure data and unstructured data and provide the structure data and unstructured data to the native accumulator. The native accumulator is configured to receive the structure data and unstructured data from the data segregator, perform one or more operations to process the received data, said operation including natural language processing techniques and store the processed data into the knowledge base. Further, the native accumulator provides the processed data to the deep learning framework and the deep learning framework is coupled to the native accumulator and is configured to process the data to provide the responses to the customer corresponding to the query through the input acceptor.

In yet another embodiment, the present invention provides a non-transitory computer-readable storage medium storing program instructions for providing aid to the industrial workforce based on intelligent learning, the instructions, when executed, perform the steps of receiving a query via an input acceptor, routing the query to an autodidact engine, said autodidact engine comprising a knowledge base and a native accumulator. The program instructions when executed performs the steps of receiving, by a data segregator, data associated with a product or services from one or more data sources, said data sources including at least a product data source, a customer data source and a tribal knowledge source and segregating, by the data segregator, the received data from said data sources into structured and unstructured data. Further, program instructions when executed performs the steps of providing, by the data segregator, the structured and the unstructured data to the native accumulator and performing, by the native accumulator, one or more operations to process the received data from the segregator. Further, program instructions when executed performs the steps of storing the processed data from the native accumulator into the knowledge base. Further, the deep learning framework is executed to process the data from the native accumulator and provides the responses to the customer corresponding to the query received through the user input acceptor.

In a further embodiment, the present invention provides a feedback module coupled to the autodidact engine, said feedback module is configured to receive feedback from one or more customer through the input acceptor, said feedback corresponds to the responses provided by the autodidact engine. The deep learning framework is trained based on the feedback received from one or more customers corresponding to the responses provided by the autodidact engine.

In a further embodiment, the native accumulator is configured to process the received structured and unstructured data from data sources by applying natural language processing techniques and industrial vernacular libraries.

In a further embodiment, the knowledge base of autodidact engine is updated based on the data processed by the native accumulator, the data being accumulated from one or more sources including the product data source, the customer data source and the tribal knowledge source.

In a further embodiment, the knowledge base comprises various static and dynamic data covering the product, users document, management system. The product data source comprises data from catalog, product manuals, user documentations. The customer data source comprises data from logbook, system operating procedure, maintenance procedures, manuals. The tribal knowledge source comprises data and knowledge acquired by expertise and product experts.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure.

FIG. 1 illustrates a system for providing aid to the industrial workforce in an industrial process, in accordance with one embodiment of the present disclosure;

FIG. 2 illustrates a system for providing aid to the industrial workforce in an industrial process, in accordance with another embodiment of the present disclosure;

FIG. 3 illustrates block diagram of various embodiments of the system, in accordance with an embodiment of the present disclosure;

FIG. 4 illustrates a flow diagram of data segregation from one or more data sources, in accordance with an embodiment of the present disclosure;

FIG. 5 illustrates a flow diagram of data processing using natural language processing (NPL), in accordance with an embodiment of the present disclosure;

FIG. 6 illustrates a block diagram providing various embodiments of deep learning model, in accordance with an embodiment of the present disclosure;

FIG. 7 illustrates a flow-chart for segregating data by the native accumulator, in accordance with one embodiment of the present disclosure;

FIG. 8 illustrates a flow-chart for providing aid to the workforce in an industrial process, in accordance with one embodiment of the present disclosure;

FIG. 9 illustrates an exemplary user interface according to an embodiment of the present disclosure; and

FIG. 10 illustrates general architecture of the system for implementation, in accordance with an embodiment of the present invention.

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

### DETAILED DESCRIPTION OF THE INVENTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

In general, manufacturing units or plant facilities includes numerous equipment/machines/devices, standard each operating procedure for equipment/device, operating parameters, equipment failure management, maintenance heads who are responsible for monitoring and managing the smooth operation of the facility. There are numerous challenges like handling of equipment failure, production issues, functional issues, knowing how, technical support, time management etc. In a plant facility, there are human resources including experts, equipment operators, maintenance engineers who are involved in running and executing the equipment on day-to-day basis. However, any failure in the equipment, underlying products needs to be resolved in quick turn-around time to have minimum impact on overall functioning of the facility.

Whenever there is an issue with equipment/devices/products, the workforce at the facilities have to rely on their competency, approach the in-house expertise/support team to get resolutions/propositions with interim approaches. However, such measures may take longer time resolution of the issues and often affects the overall functioning of the equipment/plant.

The present invention provides a solution to the above drawbacks by providing a method and a system, by which the workforce/frontline workers will be able to seek resolution to any issues though an interactive interface that could be deployed along with the other applications or independently hosted as a website or in a device. Through this invention, the workforce/frontline workers will be able to seek guidance through the interactive interface and get quick resolution. Particularly, the invention provides recommendations to any issues instantly by making use of knowledge base, tribal knowledge, equipment data, maintenance data, operations data, product data, customer data, user manuals. Detailed operation of the system has been provided henceforth with reference to several figures.

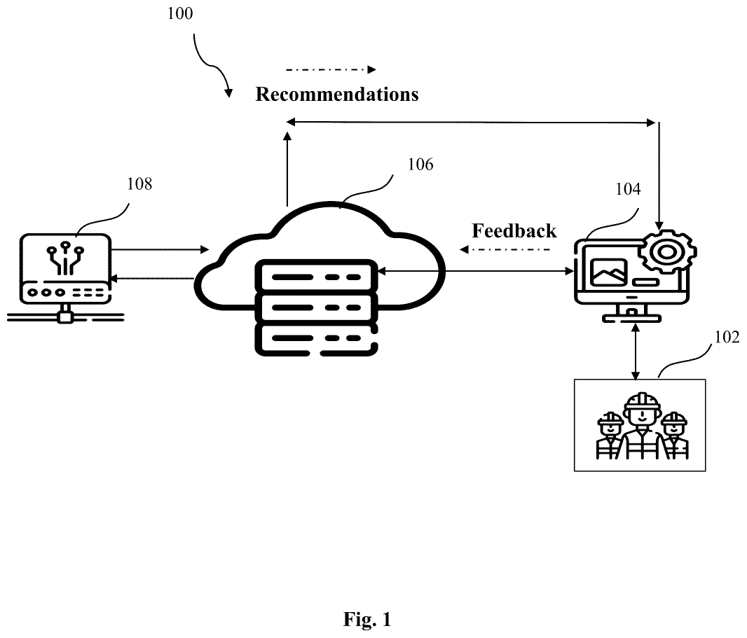

FIG. 1 illustrates an exemplary system for providing aid to the workforce 102, via a user device 104 in an industrial process, according to an embodiment of the present disclosure. The system comprises an autodidact engine 106 which is coupled to the user device 104 to receive one or more queries from the user devices 104. One or more users (collectively referred herein as “workforce”) is provided access to the user device 104. The workforce may input their queries to the user devices in various form such as text input, audio input, video input or an optical representation. In an embodiment, the user devices 104 may be deployed with an application which could be deployed along with the other applications or independently hosted as a website.

In an exemplary embodiment, the user device 104 may be a handheld device or a computer. The user device(s) 104 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein.

The autodidact engine 106 is coupled to the user device 104 via a network. The network may be a public network (e.g., the Internet), a private network (e.g., an internal localized, or closed-off network between particular devices). In some other embodiments, the network may be a hybrid network (e.g., a network enabling internal communications between particular connected devices and external communications with other devices). In various embodiments, the network may include one or more base station(s), relay(s), router(s), switch(es), routing station(s), and/or the like.

In one embodiment, the autodidact engine 106 may be configured as a cloud-based system. In the cloud-based system, application programs, file storage and other computing resources are remotely provided over the Internet through a browser. A web browser may be capable of running a program that is embedded in the browser which can further be application programming interfaces to more other applications running remotely on servers. In various embodiments, one or more user devices 104 may be communicatively coupled to transmit data to and/or receive data over the network. Such configuration(s) include, without limitation, a wired or wireless Personal Area Network (PAN), a Cloud network, Local Area Network (LAN), Metropolitan Area Network (MAN), Wide Area Network (WAN), and/or the like.

In an embodiment, the autodidact engine 106 is configured to activate a self-learning mode based on information collected from various data/information sources. Further, the autodidact engine 106 is coupled to a deep learning model/AI model 108. In an embodiment, the deep learning model 108 is based on a neural network and uses a sequence matching framework based on deep learning, which encodes a document, a question and selects a correct answer. The deep learning model 108 is configured to perform one or more data processing to provide one or more recommendations to the workforce on their user devices, based on data retrieved from autodidact engine 106.

In a further embodiment, the workforce, through their user devices 104, may submit their feedback to the autodidact engine 106 which enables the autodidact engine 106 in self learning.

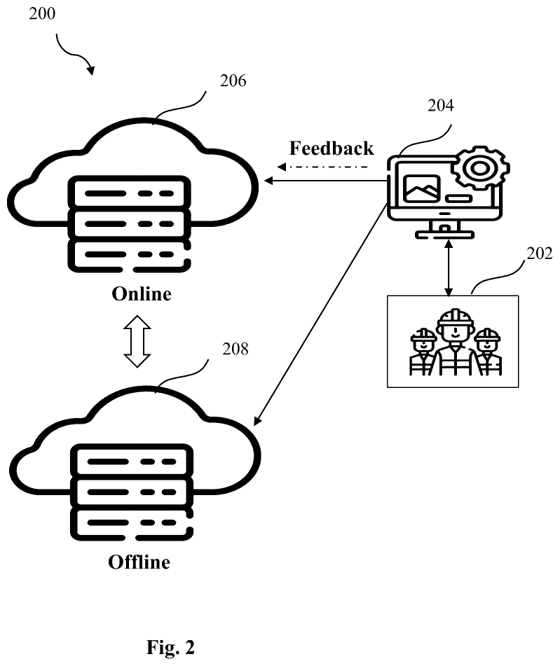

FIG. 2 illustrates an alternative arrangement, according to another embodiment 200 of the present invention. As illustrated, the autodidact engine 206, 208 may be coupled to the user devices in an online mode and in an offline mode. In scenarios, where the user devices to workforce are provided in an environment which lacks network, the user devices 204 may be configured to connect to the autodidact engine 208 in an offline mode.

In another embodiment, the user devices 204 may be configured such that the user may select between the online mode or offline mode. The offline autodidact engine 208 may be configured to map/import the data available with the online autodidact engine 206 at predetermined intervals, so that the user using the offline mode of autodidact engine 206 have full access to its functionalities.

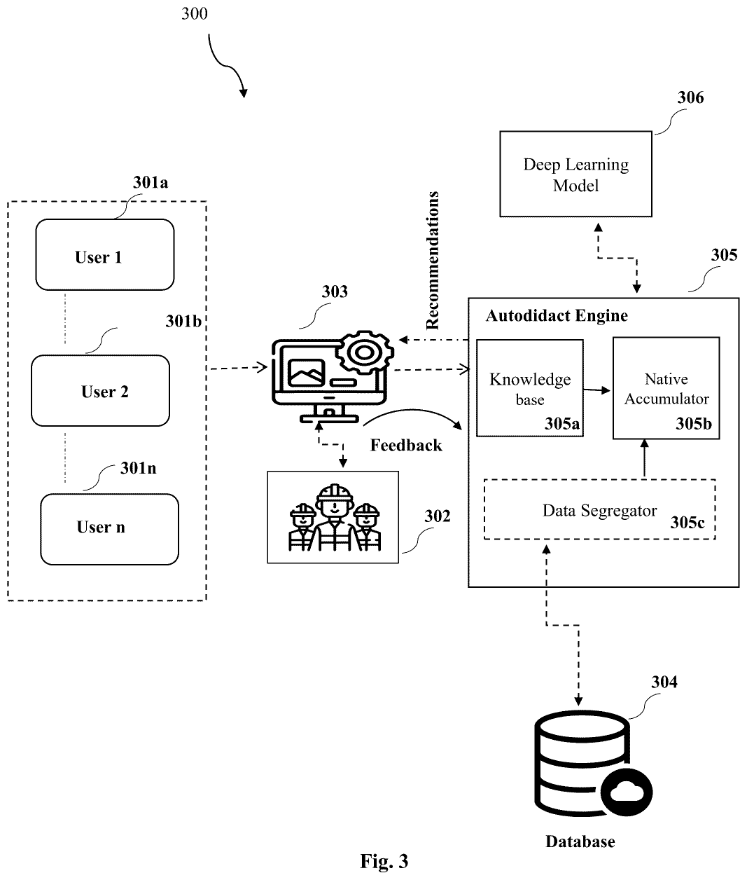

FIG. 3 illustrates block diagram of various embodiments of the system 300, in accordance with an embodiment of the present disclosure. As illustrated, one or more user devices 301a, 301b . . . 301n are coupled to an autodidact engine 305 via a network. The autodidact engine 305 in an embodiment comprises a knowledge base 305a and a native accumulator 305b. The knowledge base 305a is a data source which comprises of various static and dynamic data covering product and customer documents, data/issue management systems and expert knowledge.

In an embodiment, the knowledge base 305a may include a variety of information such as manuals, guides, and policies. The knowledge base may be an internal knowledge base storing information specific to the industrial facility, such as internal policies, procedures, and best practices. The knowledge base may be a training and Learning Management System (LMS) used for training purposes, containing educational materials, courses, and resources for employee training and development. The knowledge base may be a legal knowledge base storing legal documents, case laws, regulations, and other legal information related to the industry and the resources working in the industrial environment.

The knowledge base 305a is configured to be updated dynamically based on data processed by autodidact engine 305. The native accumulator 305b is coupled to a database 304 and is configured to process the data received from the database 304. In an embodiment, the database 304 comprises one or more data sources which may comprise product data, customer data and tribal knowledge.

In an embodiment, the product data may represent data associated with one or more assets/equipment/applications and may comprise data from catalog, user documentation manuals, project management tools (for example Jira, Confluence). The customer data may represent data associated with one or more worker/technician in an industrial facility who is executing and monitoring the assets/equipment/applications and the customer data may be from SAP, Logbook, system operating procedures, Standard maintenance procedures, customer documentation manuals etc. Further, the tribal knowledge represent data which is acquired by the expertise of the resources over the period of time, not covered in any of documents and the source of tribal knowledge can be from both Customer and Industry's internal data.

The native accumulator 305 is coupled to the database 304 via a data segregator 305c. In one embodiment, the data segregator 305c may be integral portion of the native accumulator 305. In another embodiment, the data segregator 305c may be remote to the native accumulator 305. The native accumulator 305 is configured to receive the data from the database 304 via the data segregator 305c wherein the data segregator 305c collects the data from various data sources such as product data, customer data, tribal knowledge and segregates the data into structured and unstructured data.

One or more users, who are responsible, for executing and monitoring the equipment/applications faces an issue with execution of an equipment, the user via the user device 301a, 301b . . . 301c may input a query which is subsequently forwarded to the autodidact engine 305. The user may input his queries either as text input, audio input, video input or an optical representation and the queries are forwarded to the native accumulator 305b. The native accumulator 305b of autodidact engine 305 is configured to process the query to identify the contextual meaning of the query through the natural language processing (NPL) and identify the context of the issue raised by the user through their query.

Upon receiving and processing the query, the autodidact engine 305, via the native accumulator 305b prompts retrieval of various data from the database such as customer data, product data and the tribal knowledge. The data collected from various sources such as the product data, the customer data and the tribal knowledge is forwarded to the data segregator 305c for necessary processing.

The data segregator 305c processes the data identify the structured data and un-structed data and the data are forwarded to the native accumulator 305b. The native accumulator 305c of the autodidact engine 305 is configured to receive the segregated data from the segregator 305c, data from the knowledge base 305a and carries out various sequential operations including tokenization and lemmatization. In an embodiment, industrial vernacular libraries may be used as a base for completing various tasks like stemming, stop words filtering, POS tagging for helping in accurate and precise results.

Subsequently, the processed data from data segregator and the user's query are forwarded to a deep learning model 306 which is coupled to the autodidact engine 305 for further processing. The deep learning model 306 may be neural-network based model which is configured to process the data received from the native accumulator, analyse the same in context of user's query and provide one or more recommendations to the user via the user device. The user, upon receiving recommendations, from deep learning model may implement the recommendations to troubleshoot the identified issue. In an embodiment, the deep learning model may provide one or more recommendations in order their priority and the user may implement troubleshoot based on priority of recommendations. In an example, if the user utilizes a first recommendation to troubleshoot and if the troubleshoot fails, the user may submit their feedback to the autodidact engine 305. The autodidact engine 305 transmits the feedback to the deep learning model 306 for self-learning. The deep learning model, upon receiving the feedback, utilizes the feedback to update its computational network as part of self-learning ability.

However, if the user utilizes a second recommendation which results in successful troubleshoot, the user may intimate the same to the autodidact engine, which is further forwarded to the deep learning model. In this way, the feedbacks received from the user is used for self-learning and accordingly, the priority of recommendations are altered. Further, the autodidact engine also updates its knowledge base to update the troubleshooting recommendations, thereby enriching the knowledge base.

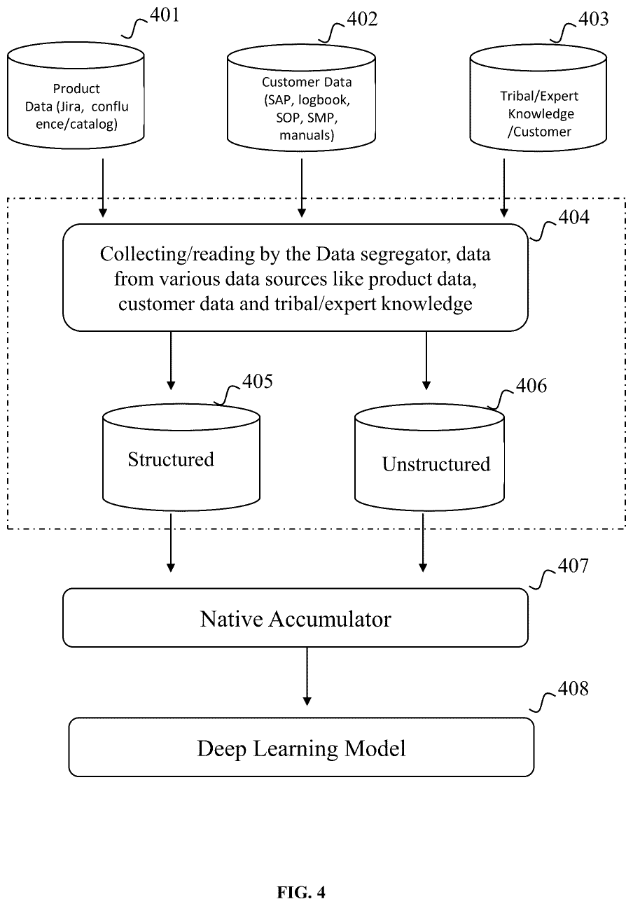

FIG. 4 illustrates a flow diagram of data segregation from one or more data sources, in accordance with an embodiment of the present disclosure. The data segregator is coupled to the database which comprises one or more data sources which may comprise product data, customer data and tribal knowledge. The product data may represent data associated with one or more assets/equipment/applications and may comprise data from catalog, user documentation manuals, project management tools (for example Jira, Confluence). The customer data may represent data associated with one or more worker/technician in an industrial facility who is executing and monitoring the assets/equipment/applications and the customer data may be from SAP, Logbook, system operating procedures, Standard maintenance procedures, customer documentation manuals etc. Further, the tribal knowledge represent data which is acquired by the expertise of the resources over the period of time, not covered in any of documents and the source of tribal knowledge can be from both Customer and Industry's internal data.

The data segregator collects data from various data sources such as product data, customer data, tribal knowledge. Generally, the data stored in these data sources may be structed or unstructured based on nature of data stored in these databases. The structured data are organized into a formatted repository. For example, the structured data may be relational data, which includes relational keys and can easily be mapped into pre-designed fields. Unstructured data are not organized in a predefined manner or does not have a predefined data model, thus it is not a good fit for a mainstream relational database. In terms of unstructured data, there are platforms for storing and managing, and is used in a variety of business intelligence and analytics applications. Example: Word, PDF, Text, Media logs.

The data and records stored in the product data, customer data, tribal knowledge may be stored in both format such as structured data and unstructured data. For the native accumulator to access and process the data, the data from these sources should be segregated into structured and unstructured data, so that different rules may be applied to these data for further processing. The data segregator receives these data and categories the data into structured and unstructured data. The structured and the un-structured data is provided to the native accumulator for further processing.

The native accumulator may process the structured data based on indexing, relational key in the data. In another embodiment, the native accumulator may process the unstructured data by applying one or more rules based on data type and non-relational data (for example, json data, xml data) in which the data fields are different.

Once the native accumulator 407 processes the structured and unstructured data, the data is forwarded to the deep learning mode 408 for further processing and providing recommendations based on neural network processing of the data and the user's query. The deep learning model may be neural-network based model which is configured to process the data received from the native accumulator, analyse the same in context of user's query and provide one or more recommendations to the user via the user device.

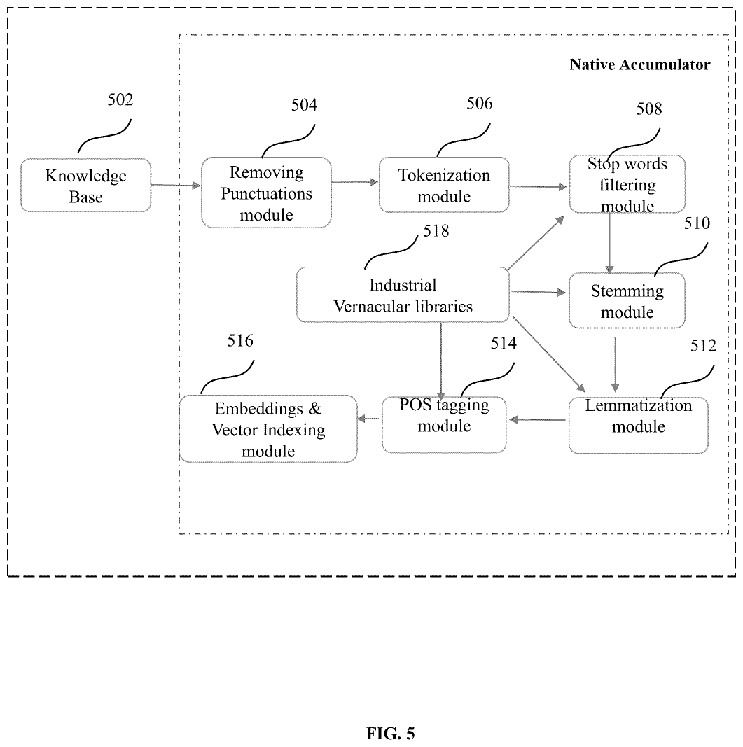

FIG. 5 illustrates a flow diagram of data processing using natural language processing (NPL) by native accumulator, in accordance with an embodiment of the present disclosure. The native accumulator receives the structured and unstructured data from the data segregator and associate knowledge base to the received data for refinement of the data, before it is forwarded to the deep learning model for further processing and providing recommendations. In a further embodiment, the native accumulator apply vector indexing and embeddings to the data of the knowledge base so that the data from the knowledge base can be associated with the structured and unstructured data based on vector similarity score.

In an embodiment, the native accumulator retrieves the data from the available knowledge base 502 and apply natural language processing techniques. At first, text cleaning methods are applied by way of removing punctuations 504. The punctuation removal process helps in treating each text equally. For example, the word data and data! are treated equally after the process of removal of punctuations. After removing punctuations, tokenization 506 of the data is performed. Tokenization focuses on dividing the text into smaller units (tokens). Subsequent to tokenization, stop word filtering 508 is applied. In the step of stop word filtering 508, stop words such as “a,” “the,” “is,” “are,” are filtered. Stop words are commonly used in Text Mining and Natural Language Processing (NLP) to eliminate words that are so widely used that they carry very little useful information. Subsequently, stemming 510 and Lemmatization 512 is performed.

In Natural Language Processing (NLP), stemming 510 and lemmatization 512 generally play important role for normalization of the words/text. Lemmatization and Stemming are performed to prepare words, text, and documents for subsequent processing. There could be words in different languages which are often derived from one another. Further, Inflected Language is a term used for a language that contains derived words. For instance, word “historical” is derived from the word “history” and hence is the derived word. Root form of derived or inflected words are attained using Stemming and Lemmatization.

Further, Part-of-speech (POS) tagging 514 is applied to the data. The POS tagging is the process of labelling words in a text with their corresponding parts of speech in natural language processing (NLP). It helps algorithms understand the grammatical structure and meaning of a text. POS tagging is a useful tool in natural language processing (NLP) as it allows algorithms to understand the grammatical structure of a sentence and to disambiguate words that have multiple meanings. It is typically performed using machine learning algorithms that are trained on a large annotated corpus of text.

In ascertaining the root form of derived or inflected words and applying POS tagging, the present invention applies industrial vernacular libraries 518 to the stop word filtering 508, stemming 510, lemmatization 512 and POS tagging 514 to derive meaningful interpretation of the text in context of the industrial process. Subsequent to applying industrial vernacular libraries, embeddings and vector indexing are determined the text of the knowledge base.

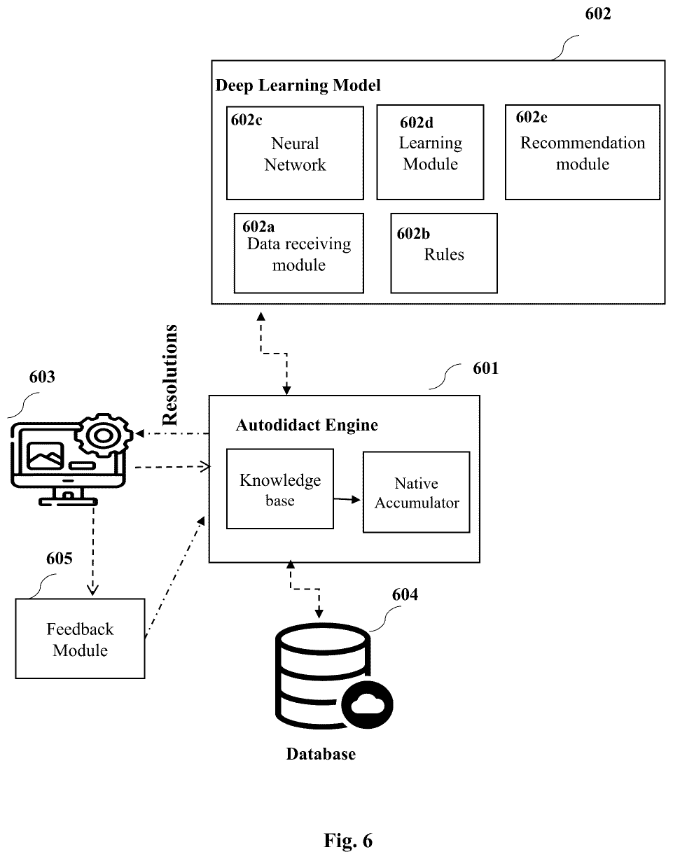

FIG. 6 illustrates a block diagram providing various embodiments of a deep learning model 602, in accordance with an embodiment of the present disclosure. The deep learning model 602 comprises a data receiving module 602a, a Rules module 602b, a neural network 602c, a learning module 602d and a recommendation module 602e. The processed data from native accumulator are forwarded to a deep learning model 602 which is coupled to the autodidact engine 305 for further processing. The data from the native accumulator is received by the receiving module 602a. Further, the deep learning module 602 comprises a neural network 602c, which is configured to process the data received from the native accumulator, analyse the same in context of user's query and provide one or more recommendations to the user. The deep learning model 602 comprises a recommendation module 602e for providing one or more recommendations to the autodidact engine which is subsequently forwarded to the users via their user devices, based on data processed by the neural network.

The user, upon receiving recommendations, from autodidact engine may implement the recommendations to troubleshoot the identified issue. In an embodiment, the autodidact engine may provide one or more recommendations in order their priority received from the deep learning model and the user may implement troubleshoot based on priority of recommendations. In an example, when the user utilizes a first recommendation to troubleshoot and if the troubleshoot fails, the user may submit their feedback to the autodidact engine 305. The autodidact engine 305 transmits the feedback to the deep learning model 306 for self-learning. The deep learning model, upon receiving the feedback, utilizes the feedback to update its computational network as part of self-learning ability.

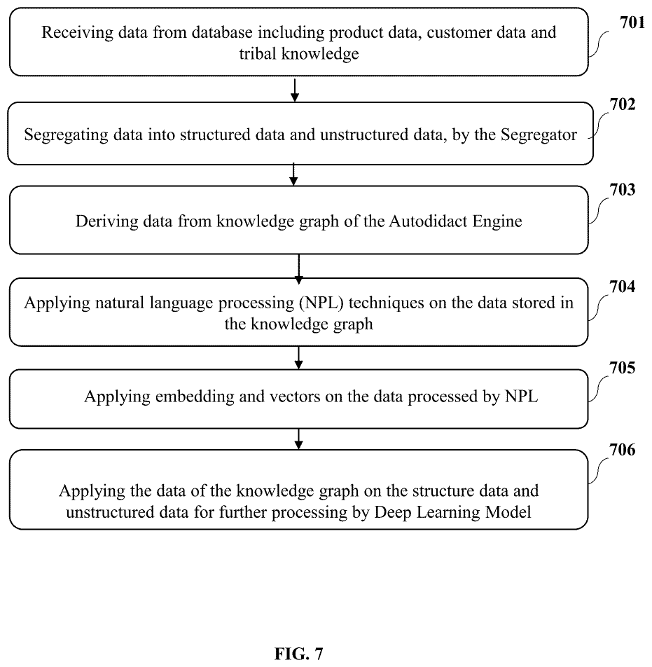

FIG. 7 illustrates a flow-chart for data segregation and data processing using NPL by the native accumulator, in accordance with one embodiment of the present disclosure. In Step 701, the native accumulator of the autodidact engine receives the data from one or more data sources and such data from sources may include product data, customer data and tribal knowledge. Source. The product data source comprises data from catalog, product manuals, user documentations. The customer data source comprises data from logbook, system operating procedure, maintenance procedures, manuals. The tribal knowledge source comprises data and knowledge acquired by expertise and product experts.

In Step 702, the native accumulator receives the product data, customer data and tribal knowledge. via a data segregator. The data segregator processes the data to derive the structured and un-structured data from the product data, customer data and tribal knowledge. The data segregator processes the data to identify the structured data and un-structed data and the data are forwarded to the native accumulator.

In Step 703, The native accumulator of the autodidact engine is configured to receive the segregated data from the segregator and the data from the knowledge base.

In Step 704, the native accumulator carries out various sequential operations including tokenization and lemmatization. In an embodiment, industrial vernacular libraries may be used as a base for completing various tasks like stemming, stop words filtering, POS tagging for helping in accurate and precise results. In an embodiment, the native accumulator retrieves the data from the available knowledge base and apply natural language processing techniques. At first, text cleaning methods are applied by way of removing punctuations. The punctuation removal process helps in treating each text equally. After removing punctuations, tokenization of the data is performed. Tokenization focuses on dividing the text into smaller units (tokens). Subsequent to tokenization, stop word filtering is applied, wherein the stop words are commonly used in Text Mining and Natural Language Processing (NLP) to eliminate words that are so widely used that they carry very little useful information. Subsequently, stemming and Lemmatization is performed. In Natural Language Processing (NLP), stemming and lemmatization plays important role for normalization of the words/text. Lemmatization and Stemming are performed to prepare words, text, and documents for subsequent processing. There could be words in different languages which are often derived from one another. Further, Inflected Language is a term used for a language that contains derived words. Root form of derived or inflected words are attained using Stemming and Lemmatization. Further, Part-of-speech (POS) tagging is applied to the data. The POS tagging is the process of labelling words in a text with their corresponding parts of speech in natural language processing (NLP). It helps algorithms understand the grammatical structure and meaning of a text. POS tagging is a useful tool in natural language processing (NLP) as it allows algorithms to understand the grammatical structure of a sentence and to disambiguate words that have multiple meanings. It is typically performed using machine learning algorithms that are trained on a large annotated corpus of text. Further, in ascertaining the root form of derived or inflected words and applying POS tagging, the step 704 applies industrial vernacular libraries to the stop word filtering, stemming, lemmatization and POS tagging to derive meaningful interpretation of the text in context of the industrial process.

In Step 705, subsequent to applying industrial vernacular libraries, embeddings and vector indexing are applied on the text of the knowledge base.

In Step 706, the data of the knowledge graph are applied on the segregated product data, customer data and tribal knowledge and the data is forwarded to the deep learning model for further processing. The deep learning model may be neural-network based model which is configured to process the data received from the native accumulator, analyse the same in context of user's query and provide one or more recommendations to the autodidact engine which is subsequently forwarded to the user via the user device.

The above steps in FIG. 7 illustrated the processing of product data, customer data, tribal knowledge and also, the data from the knowledge graph, which is finally processed by the deep learning model in providing one or more recommendations to the user operating the equipment in an industrial environment.

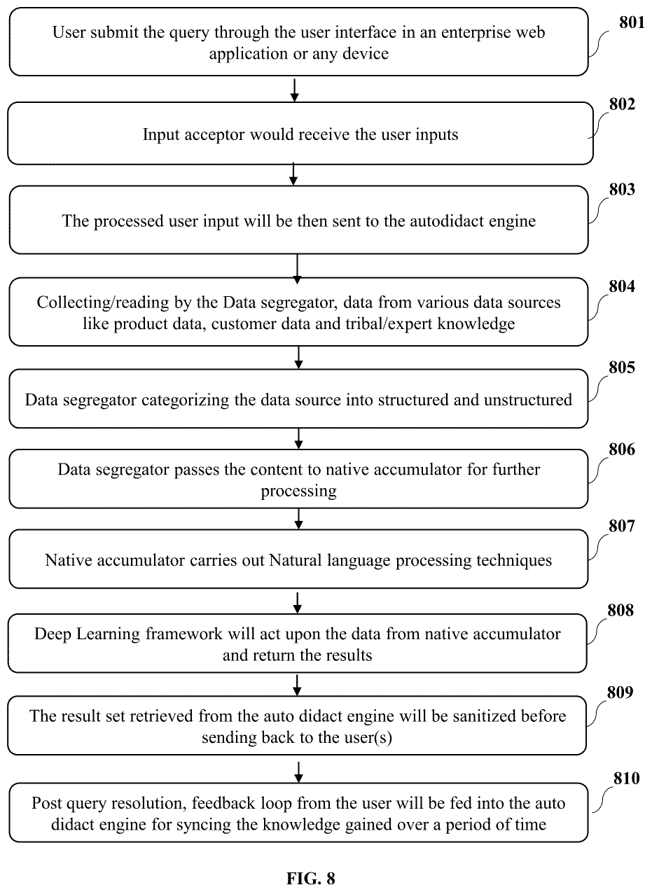

FIG. 8 illustrates a flow-chart for providing aid to the workforce in an industrial process, in accordance with one embodiment of the present disclosure.

In Step 801, one or more users, who are responsible, for executing and monitoring the equipment/applications when faces an issue with execution of an equipment, the user via the user device may input a query. The user may input his queries either as text input, audio input, video input or an optical representation.

In Step 802, the queries are forwarded to the native accumulator of the autodidact engine. In Step 803, the native accumulator is configured to process the query to identify the contextual meaning of the query through the natural language processing (NPL) and other image/audio processing techniques and determine the context of the issue raised by the user through their query. In one embodiment, the native accumulator converts the text/audio/video/optical representation query into a format from which the contextual meaning of query can be derived and vector embeddings can be associated with the query.

In Step 804, the native accumulator of the autodidact engine, based on identification of at least one product, customer associated with the user's query, retrieves the data from one or more data sources and such data from sources may include product data, customer data and tribal knowledge. Source. The product data source comprises data from catalog, product manuals, user documentations. The customer data source comprises data from logbook, system operating procedure, maintenance procedures, manuals. The tribal knowledge source comprises data and knowledge acquired by expertise and product experts. In one embodiment, the native accumulator receives the product data, customer data and tribal knowledge. via a data segregator.

In Step 805, the data segregator processes the data to derive the structured and un-structured data from the product data, customer data and tribal knowledge. The data segregator processes the data to identify the structured data and un-structed data and in Step 806, the segregated data are forwarded to the native accumulator.

In Step 807, the native accumulator retrieves the data from the knowledge base and apply natural language processing techniques. At first, text cleaning methods are applied by way of removing punctuations. After removing punctuations, tokenization of the data is performed. Tokenization focuses on dividing the text into smaller units (tokens). Subsequent to tokenization, stop word filtering is applied, wherein the stop words are commonly used in Text Mining and Natural Language Processing (NLP) to eliminate words that are so widely used that they carry very little useful information. Subsequently, stemming and Lemmatization is performed. Root form of derived or inflected words are attained using Stemming and Lemmatization. Further, Part-of-speech (POS) tagging is applied to the data. The POS tagging is the process of labelling words in a text with their corresponding parts of speech in natural language processing (NLP). It helps algorithms understand the grammatical structure and meaning of a text. POS tagging is typically performed using machine learning algorithms that are trained on a large annotated corpus of text. Further, in ascertaining the root form of derived or inflected words and applying POS tagging, the industrial vernacular libraries are applied to the stop word filtering, stemming, lemmatization and POS tagging to derive meaningful interpretation of the text in context of the industrial process.

In Step 808, the data of the knowledge graph are applied on the segregated product data, customer data and tribal knowledge and the data is forwarded to the deep learning model for further processing. The deep learning model may be neural-network based model which is configured to process the data received from the native accumulator, analyse the same in context of user's query.

In Step 809, the deep learning model may determine one or recommendations and provide the same to the autodidact engine, which is subsequently forwarded to the user via user devices after necessary sanitization of the recommendations. In one embodiment, the sanitization of the recommendations may include covering the recommendations into a readable form which may be useful to the user receiving the recommendations.

In Step 810, the autodidact may provide one or more recommendations in order their priority and the user may implement troubleshoot based on priority of recommendations. In an example, if the user utilizes a first recommendation to troubleshoot and if the troubleshoot fails, the user may submit their feedback to the autodidact engine. The autodidact engine transmits the feedback to the deep learning model for self-learning. The deep learning model, upon receiving the feedback, utilizes the feedback to update its computational network as part of self-learning ability.

The above steps in FIG. 8 illustrated the procedures in receiving the query from the user, processing the query, accessing the product data, customer data, tribal knowledge and also, the data from the knowledge graph, which is finally processed by the deep learning model in providing one or more recommendations to the user operating the equipment in an industrial environment.

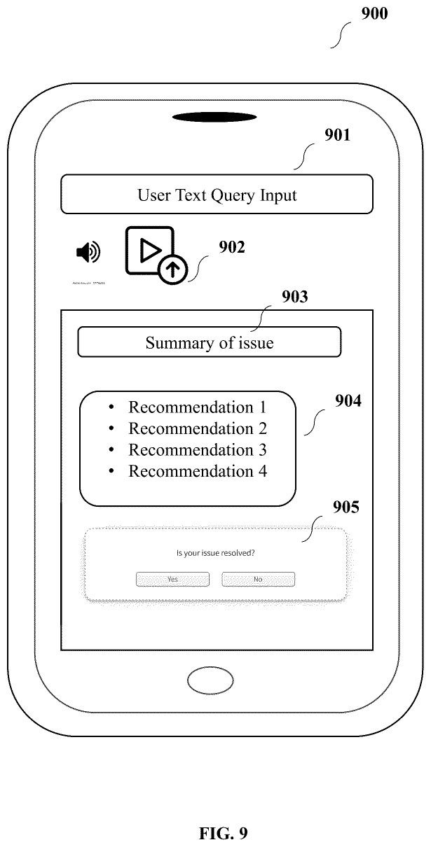

FIG. 9 illustrates an exemplary user interface 900 according to an embodiment of the present disclosure. The user interface 900 comprises an input box 901, where the user/customer who are responsible for monitoring and operating the equipment in an Industry, can enter their query regarding the issue encountered in operation of the equipment. In an embodiment, the user may enter their text query mentioning the issue and submit it. In alternative embodiment, the user may have option to submit input by way of audio/video/optical representation 902.

Once the user submits their query, the autodidact system in conjunction with native accumulator and deep learning model provides the user on their user interface, one or more recommendations 904. In an embodiment, a prompt box 903 may be provided which may indicate the summary of the issue captured by the autodidact engine for user's verification. The user, upon receiving recommendations, implement the recommendations one by one to troubleshoot the identified issue. In an example, when the user utilizes a first recommendation to troubleshoot and if the troubleshoot fails, the user may submit their feedback 905 to the autodidact engine.

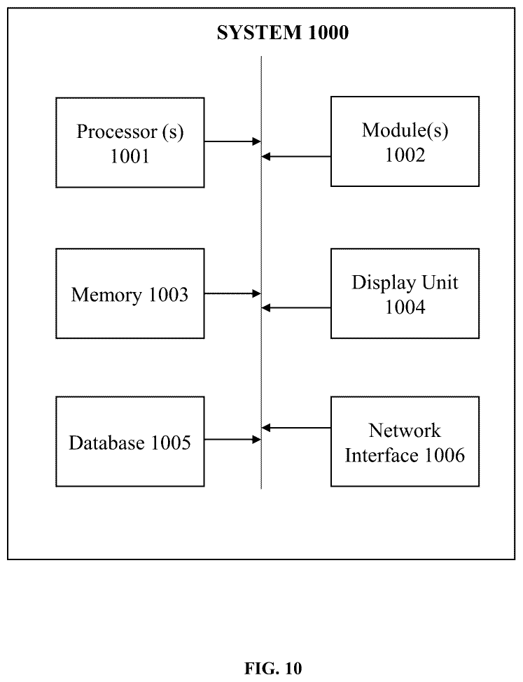

FIG. 10 illustrates a general block diagram of the system, according to an embodiment of the present disclosure.

In an example, the processor(s) 1001 may be a single processing unit or a number of units, all of which could include multiple computing units. The processor(s) 1001 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1001 is configured to fetch and execute computer-readable instructions and data stored in a memory 1003.

The memory 1003 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1002 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1503 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1503 when executed by the processor(s) 1001 may be configured to perform any of the described functionalities. According to an embodiment, the module 1002 includes one or more modules discussed above with reference to FIG. 5 and FIG. 6. In an alternate embodiment, the functions of the aforesaid modules may be performed by the processor(s) 1001.

As a further example, the database 1005 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 1001, and the modules/engines/units.

The modules/engines/units 1002 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to make a determination or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 1004 includes a computer monitor, a touch screen, an output device capable of displaying the graphics, and the like. The display unit 1004 is configured to display visual output in desktops, laptops, and workstations. The display unit 1004 may come in different sizes, resolutions, and types (such as LCD, LED, or OLED).

As a further example, the network interface 1006 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms operator, person, employee, worker, labor, personnel, workforce, supervisor, and manager have been used interchangeably throughout the draft and corresponds to an individual working in an industry or directly or indirectly managing operations in the industrial environment.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

What is claimed is:

1. A method for providing aid to the industrial workforce based on intelligent learning, comprising:
receiving a query via an input acceptor;
routing the query to an autodidact engine, said autodidact engine comprising a knowledge base and a native accumulator;
receiving, by a data segregator, data associated with a product or services from one or more data sources, said data sources including at least a product data source, a customer data source and a tribal knowledge source;
segregating, by the data segregator, the received data from said data sources into structured and unstructured data;
providing, by the data segregator, the structured and the unstructured data to the native accumulator;
performing, by the native accumulator, one or more operations to process the received data from the segregator;
storing the processed data from the native accumulator into the knowledge base;
executing a deep learning framework to process the data from the native accumulator; and
providing the responses to the customer corresponding to the query received through the user input acceptor.

2. The method of claim 1, further comprising:
receiving a feedback from one or more customer through the input acceptor corresponding to the responses provided by the autodidact engine.

3. The method of claim 2, further comprising:
training the deep learning framework based on the feedback received from one or more customers corresponding to the responses provided by the autodidact engine.

4. The method of claim 1, further comprising:
providing autodidact engine in online or offline mode, which is accessible by one or more customers through the input acceptor.

5. The method of claim 1, wherein the query received from the customer though the input acceptor includes audio, video or text-based query.

6. The method of claim 1, comprising:
processing the received structured and unstructured data from data sources by applying natural language processing techniques and industrial vernacular libraries.

7. The method of claim 1, comprising:
updating the knowledge base based on the data processed by the native accumulator, the data being accumulated from one or more sources including the product data source, the customer data source and the tribal knowledge source.

8. The method of claim 1, wherein the data collected from product data source, the customer data source and the tribal knowledge source includes the data pertaining to an industrial product or an industrial process.

9. The method of claim 8, wherein the industrial product data comprises at least one or more of product performance, product health index, product degradation index, remaining useful life of product and the industrial process data comprises at least one or more of monitoring process performance, determining process anomaly and predicting the life of the product.

10. A system for providing aid to the industrial workforce based on intelligent learning, comprising:
an input acceptor for receiving a query from a customer;
an autodidact engine coupled to the input acceptor for receiving the query, said autodidact engine comprising a knowledge base, a native accumulator and a deep learning framework;
a data segregator coupled to the native accumulator;
wherein the data segregator is configured to:
receive data from one or more sources, said sources including product data, customer data and tribal knowledge data;
segregate the received data into structure data and unstructured data; and
provide the structure data and unstructured data to the native accumulator;
wherein the native accumulator is configured to:
receive the structure data and unstructured data from the data segregator;
performing one or more operations to process the received data, said operation including natural language processing techniques;
storing the processed data into the knowledge base; and
provide the processed data to the deep learning framework;
the deep learning framework coupled to the native accumulator and is configured to process the data to provide the responses to the customer corresponding to the query through the input acceptor.

11. The system of claim 10, further comprising:
a feedback module coupled to the autodidact engine, said feedback module is configured to receive feedback from one or more customer through the input acceptor, said feedback corresponds to the responses provided by the autodidact engine.

12. The system of claim 11, wherein the deep learning framework is trained based on the feedback received from one or more customers corresponding to the responses provided by the autodidact engine.

13. The system of claim 10, wherein the autodidact engine is configured to be provided in online or offline mode, which is accessible by one or more customers through the input acceptor.

14. The system of claim 10, wherein the input acceptor receives queries from the customer in audio, video or text-based format.

15. The system of claim 10, wherein the native accumulator is configured to process the received structured and unstructured data from data sources by applying natural language processing techniques and industrial vernacular libraries.

16. The system of claim 10, wherein the knowledge base of autodidact engine is updated based on the data processed by the native accumulator, the data being accumulated from one or more sources including the product data source, the customer data source and the tribal knowledge source.

17. The system of claim 10, wherein the data collected from product data source, the customer data source and the tribal knowledge source includes the data pertaining to an industrial product or an industrial process.

18. The system of claim 17, wherein the industrial product data comprises at least one or more of product performance, product health index, product degradation index, remaining useful life of product and the industrial process data comprises at least one or more of monitoring process performance, determining process anomaly and predicting the life of the product.

19. The system of claim 10, wherein:
the knowledge base comprises various static and dynamic data covering the product, users document, management system;
the product data source comprises data from catalog, product manuals, user documentations;
the customer data source comprises data from logbook, system operating procedure, maintenance procedures, manuals; and
the tribal knowledge source comprises data and knowledge acquired by expertise and product experts.

20. A non-transitory computer-readable storage medium storing program instructions for providing aid to the industrial workforce based on intelligent learning, the instructions, when executed, perform the steps of:
receiving a query via an input acceptor;
routing the query to an autodidact engine, said autodidact engine comprising a knowledge base and a native accumulator;
receiving, by a data segregator, data associated with a product or services from one or more data sources, said data sources including at least a product data source, a customer data source and a tribal knowledge source;
segregating, by the data segregator, the received data from said data sources into structured and unstructured data;
providing, by the data segregator, the structured and the unstructured data to the native accumulator;
performing, by the native accumulator, one or more operations to process the received data from the segregator;
storing the processed data from the native accumulator into the knowledge base;
executing a deep learning framework to process the data from the native accumulator; and
providing the responses to the customer corresponding to the query received through the user input acceptor.
